(19) United States
(12) Patent Application Publication
(10) Pub. No.: US 2013/0220932 A1
(43) Pub. Date: Aug. 29, 2013

(54) METHOD FOR FILTERING WATER IN AN AQUARIUM; FILTRATION UNIT AND REPLACEMENT KIT FOR PERFORMING SAID METHOD

(71) Applicant: Elio MARIONI, Dueville (Vicenza) (IT)

(72) Inventor: Elio MARIONI, Dueville (Vicenza) (IT)

(73) Assignee: ASKOLL HOLDING S.R.L., Povolaro di Dueville (Vicenza) (IT)

(21) Appl. No.: 13/406,084

(22) Filed: Feb. 27, 2012

(51) Int. Cl. A01K 63/04; B01D 37/00; B01D 36/00; C02F 1/28

(52) U.S. Cl. 210/663; 210/167.25; 210/85; 210/683

(57) ABSTRACT

A method is described that is particularly effective for the filtration of an aquarium by means of a filtration unit wherein a cartridge containing activated carbon is cyclically replaced by a cartridge containing material for the removal of nitrate and/or phosphate ions. A plurality of mechanical filters may also be alternately replaced, so that a colony of nitrifying bacteria is always preserved on one of the filters. Also described is a filtration unit that allows the application of the method and a replacement kit containing both the cartridge containing activated carbon and the cartridge containing material for the removal of nitrate and/or phosphate ions, and preferably also one of the mechanical filters.

### FIELD OF APPLICATION

The present invention, in its most general aspect, refers to a method for filtering aquarium water, in particular for a domestic aquarium.

The invention also refers to a filtration unit, possibly integrated in an aquarium, as well as a replacement kit, both intended to allow the above-mentioned filtration method to be applied.

### PRIOR ART

As is well known to those skilled in the art, the correct maintenance of an aquarium generally requires constant circulation and filtration of the water that contains the fish species kept in the aquarium.

To ensure that these requirements are met, specific filtration units are used, inside of which the water is made to circulate along a predetermined filtration path. Such filtration units draw in water from the aquarium tank and reintroduce it purified, after passing through said filtration process.

The filtration of the water takes place in several steps, each connected with separate subsequent stages in the filtration unit. More particularly up to three different stages may be present, respectively called mechanical, biological and chemical filtration.

The stage of mechanical filtration, intended to remove the coarser particulate matter present in the water, makes use of a special sponge, usually made of polyurethane material. The water flows straight through the sponge while the material suspended in the water is retained by it.

One will note that these sponges are subject to clogging and therefore must be periodically replaced to ensure continued effectiveness of the filter installation.

Preferably downstream from the mechanical filtration the stage of biological filtration takes place, defined by a compartment filled with solid elements, generally made of a ceramic material characterized by a high surface/volume ratio. The surfaces of these elements promote the formation of colonies of nitrifying bacterial flora that break down the toxic nitrogenous catabolites in the water (such as ammonium and nitrite) into compounds that are less harmful to the fish population of the aquarium (nitrates).

Lastly the chemical filtration stage includes the use of filtration material intended to remove other unwanted compounds such as nitrates, phosphates and organic compounds. In particular ion-exchange resins are used to remove nitrate and phosphate ions, whereas for the removal of organic compounds preferably activated carbon is used.

One should note that the effectiveness of the materials used in the chemical filtration stage diminishes rapidly over time due to saturation, which necessitates periodical replacement.

The removal of nitrates and phosphates from the aquarium water is mainly intended to prevent the proliferation of algae inside the aquarium tank; the removal of organic substances, on the other hand, is above all aimed at avoiding deterioration of water quality.

Ideally it would be preferable to have a filtration stage with both the anti-phosphate and anti-nitrate resins and the activated carbon. However such a solution would result in a greater size and shape of the chemical filter, which would in many cases be incompatible with the available space in the filtration unit. In view of this drawback, suppliers often opt to eliminate one of the filtration stages described above.

Again from the point of view of reducing the dimensions of the filtration unit, in some cases a separate stage of biological filtration is eliminated, confiding instead in the proliferation of nitrifying bacteria on the polyurethane sponge that forms the mechanical filtration stage.

This solution, although on the one hand allowing for reduced sizes, on the other hand creates a drawback in connection with the periodical replacement of the mechanical filter. Each time the filter is replaced, the bacterial flora are removed and a certain period of time is necessary for them to reform and again ensure adequate biological filtration.

### SUMMARY OF THE INVENTION

The technical problem at the basis of the present invention is that of finding a filtration method that guarantees complete efficacy in the different filtration stages, allowing at the same time that the filter unit remains compact and low-cost.

The above-mentioned technical problem is resolved by a method for filtering the water in an aquarium by means of a filtration unit, said method comprising:

leading water circulation along a filtration path that comprises at least a chemical filtration stage, said chemical filtration stage comprising at least a cartridge containing activated carbon or a cartridge containing material for the removal of nitrate and/or phosphate ions;

cyclically replacing said cartridge, over time alternating between cartridges with activated carbon and cartridges with material for the removal of nitrate and/or phosphate ions.

Thanks to the constant alternation between cartridges with activated carbon and cartridges with material for the removal of nitrate and/or phosphate ions, an optimal filtration balance is obtained, preventing the formation of algae as well as deterioration of water quality. This result is obtained by using cartridges that are small in size, without negatively impacting maintenance costs of the installation.

In a particular embodiment of the above-mentioned method the filtration path also comprises at least a mechanical filtration stage, said mechanical filtration stage comprising at least two mechanical filters. The method thus comprises the following cyclically repeating steps:

replacing a number of mechanical filters less than the total number of mechanical filters in the mechanical filtration stage;

replacing, in a subsequent moment, a number of mechanical filters less than the total number of mechanical filters in the mechanical filtration stage, said number of filters at least containing the mechanical filters that have not been replaced in the previous step.

This way of replacing the mechanical filters makes it possible to retain at the end of each maintenance operation at least one mechanical filter (preferably consisting of a polyurethane sponge) that has already been used in the previous filtration cycle. This solution proves to be particularly advantageous because the already used filter will contain a colony of nitrifying bacteria that performs an important biological filtration of the water circulating in the filtration unit.

Other particularly advantageous embodiments of the method according to the invention are described in the dependent claims of the present application.

The method described above can be implemented by a filtration unit for aquaria that comprises a filtration path and means to lead the circulation of aquarium water along said path, said filtration path comprising at least one chemical filtration stage containing alternately and in a replaceable manner a cartridge containing activated carbon or a cartridge containing material for the removal of nitrate and/or phosphate ions.

Other particularly advantageous embodiments of the filtration unit are described in the dependent claims of the present application.

The method described above can be implemented by using a replacement kit for filter units for aquaria comprising a cartridge containing activated carbon and a cartridge containing material for the removal of nitrate and/or phosphate ions, said cartridges being able to replace each other inside the aquarium filter unit.

The kit preferably also comprises a mechanical filter, in particular a polyurethane sponge or other type.

Further characteristics and advantages of the invention will become clear from the following description of a number of specific embodiments given by way of non-limiting example, with reference to the enclosed drawings.

### BRIEF DESCRIPTION OF THE DRAWINGS

FIG. 1 schematically represents a small-sized aquarium comprising a filtration unit according to the present invention; the continuous arrows indicate a filtration path inside the unit;

FIG. 2 represents a flowchart for the filtration method according to the present invention, obtained with the filtration unit of FIG. 1;

FIG. 3 schematically represents a medium-sized aquarium comprising a filtration unit according to the present invention; the continuous arrows indicate a filtration path inside the unit;

FIG. 4 represents a flowchart for the filtration method according to the present invention, obtained with the filtration unit of FIG. 3;

FIG. 5 schematically represents a large-sized aquarium comprising a filtration unit according to the present invention; the continuous arrows indicate a filtration path inside the unit;

FIG. 6 represents a flowchart for the filtration method according to the present invention, obtained with the filtration unit of FIG. 5;

FIG. 7 schematically represents a very large-sized aquarium comprising a filtration unit according to the present invention; the continuous arrows indicate a filtration path inside the unit;

FIG. 8 represents a flowchart for the filtration method according to the present invention, obtained with the filtration unit of FIG. 7;

FIG. 9 schematically represents a replacement kit to be used for the filtering method of FIG. 2;

FIG. 10 schematically represents a replacement kit to be used for the filtration methods of FIGS. 4, 6, 8;

FIG. 11 represents an electronic device for the realization of the filtration methods of FIGS. 2, 4, 6, 8;

FIG. 12 represents a flowchart of the functionality of the electronic device of FIG. 11.

### DETAILED DESCRIPTION

The present invention regards a method for filtering the water in an aquarium, as well as a filtration unit incorporated in an aquarium and a replacement kit specifically designed for said filtration method.

The following describes in detail four different embodiments of the filtration unit, intended for aquaria progressively increasing in size. To differentiate between them in the following description, the four variants are identified as 1_{S}, 1_{M}, 1_{L} and 1_{XL}, with the subscript indicating the progressively increasing size of the device.

For each variant of the filtration unit a respective embodiment of the filtration method is described. The different embodiments of the filtration unit and the filtration method are illustrated in the attached drawings 1-8. Where possible the same reference numbers have been used to indicate the same components or steps of the procedure, sometimes followed by the subscript S, M, L or XL to indicate the filtration unit being referred to.

Note that the filtration units are represented in the respective figures in accordance with their normal operational configuration; in the following description, all positions and orientations, both relative and absolute, of the various components of the unit, defined by means of terms such as upper and lower, above and below, horizontal and vertical or similar terms, should always be interpreted with reference to that configuration.

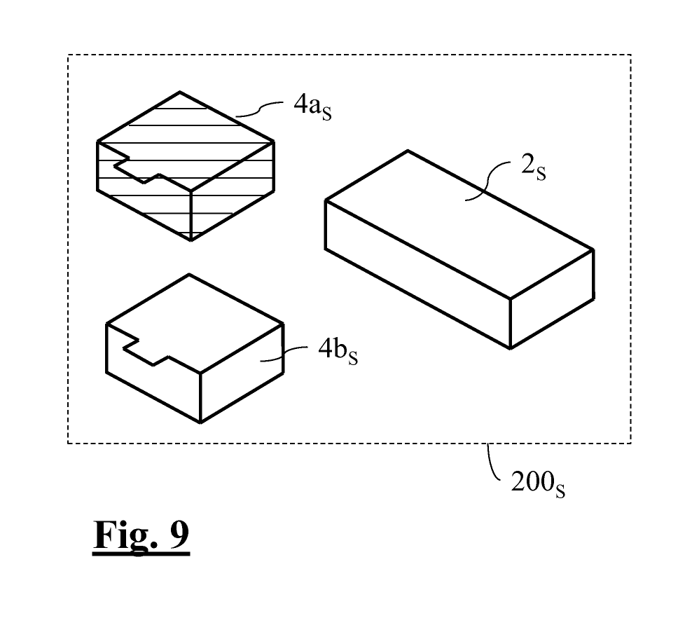

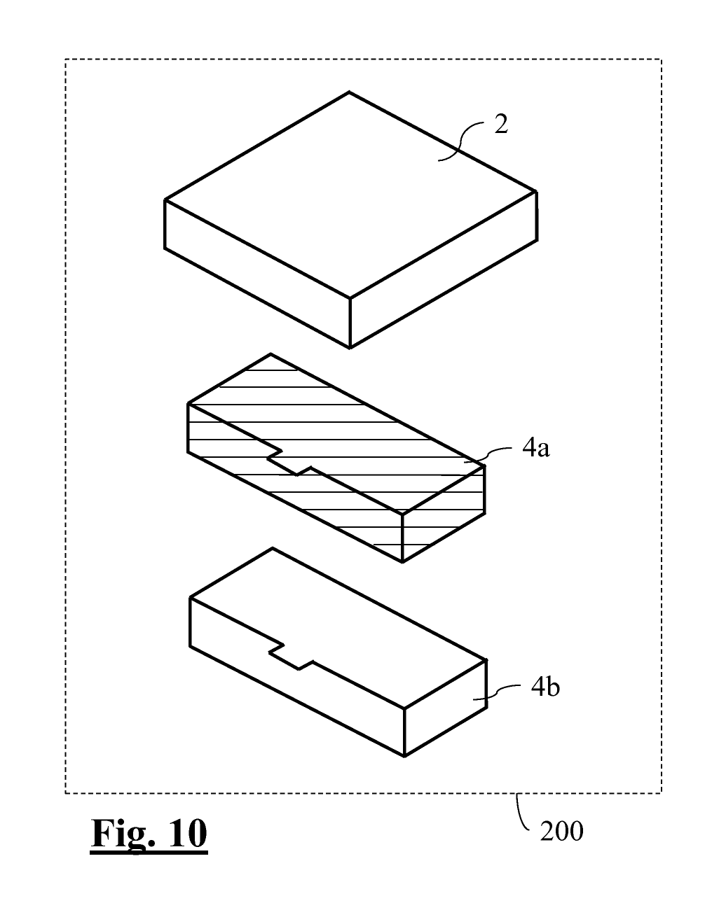

For all variants of the filtration unit described below the replacement kit 200_{S}, 200 is required. A first replacement kit 200_{S}, for use with the filtration unit 1_{S}, is represented in FIG. 9; a second replacement kit 200, intended for use with the filtration units 1_{M}, 1_{L}, 1_{XL}, is represented in FIG. 10.

Both replacement kits 200_{S}, 200 contain three separate components: a mechanical filter 2_{S}, 2; a cartridge containing activated carbon 4a_{S}, 4a; and a cartridge containing material for the removal of nitrate and/or phosphate ions 4b_{S}, 4b. In the preferred embodiment described here the mechanical filter 2_{S}, 2 is formed by a sponge made of a polyurethane material. The cartridges 4a_{S}, 4a, 4b_{S}, consist of an external container, through which opportunely the water to be filtered can pass, containing the active material. To allow the passage of the water that is to be filtered at least two faces of the cartridge are pervious; preferably all lateral surfaces, the top surface and the bottom surface of the cartridge are pervious. The material for the removal of nitrate ions and/or phosphate can be in the form of resins known from prior art. In the following description the cartridges containing the activated carbon 4a_{S}, 4a and the cartridges containing the material for the removal of nitrate and/or phosphate ions 4b_{S}, 4b will both be called chemical filtration cartridges.

An ideal service period T of two weeks is indicated for the chemical filtration cartridges, 4a_{S}, 4a, 4b_{S}, 4b, after which the cartridges will become saturated and lose much of their filtration capacity. For the mechanical filters 2 an ideal service period 2·T of four weeks is indicated. After that time limit the filters will become clogged and lose much of their filtration capacity.

The components contained in the first replacement kit 200_{S} and the second replacement kit 200 differ in their relative sizes; in particular the components of the first replacement kit 200_{S} are smaller in size.

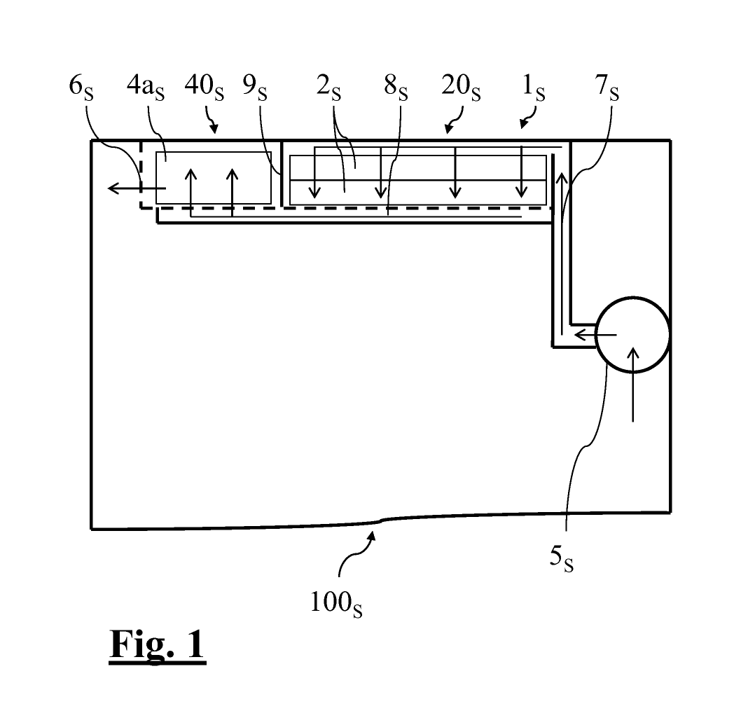

With reference to FIG. 1 the number 100_{S} identifies a small-sized aquarium into which the filtration unit 1_{S} is integrated at the top.

The filtration unit 1_{S} comprises a pump 5_{S} that draws in the water inside the aquarium 100_{S} to circulate it along a filtration path 7_{S}; 20_{S}; 8_{S}; 40_{S}.

The pump 5_{S}, located upstream of the filtration path 7_{S}; 20_{S}; 8_{S}; 40_{S}, leads the water through a delivery duct 7_{S}. The duct ends in a vertical passage that connects with the upper end of the filtration unit 1_{S}, which opens into a first compartment 20_{S}.

The first compartment 20_{S} is designed to house two mechanical filters 2_{S}, of the type contained in the first replacement kit 200_{S} previously described. The two mechanical filters 2_{S} are placed one above the other and they rest on an open grid that covers a connecting duct 8_{S}. The water coming from the delivery duct 7_{S} then passes through the two mechanical filters 2_{S} by gravitational effect, where the particulate matter suspended in the water is captured, thus performing the mechanical filtration. Note that on the sponges that form the mechanical filters 2_{S} in time nitrifying bacterial flora will establish themselves. After the formation of these flora, the mechanical filters will in this way also perform a biological filtration of the water that passes through them.

In the light of the above the first compartment 20_{S} thus defines a mechanical/biological filtration stage of the filtration unit 1_{S}.

The connection duct 8_{S} extends below a second compartment 40_{S}, contiguous with the first compartment and separated from it by means of a vertical partition 9_{S} above the duct. This second compartment has an open grid at the bottom that separates it from the connection duct 8_{S} and it can receive a cartridge containing activated carbon 4a_{S}, or alternately a cartridge containing material for the removal of nitrate and/or phosphate ions 4b_{S}. Both cartridges are of the type contained in the first replacement kit 200_{S} previously described. The water coming from the connection duct 8_{S} thus enters the second compartment 40_{S} at the lower end and is subsequently reintroduced into the aquarium 100_{S} through an open exit grid 6_{S} opposite the vertical partition 9_{S}. The water that passes through the second compartment 40_{S} transits through the interior of the cartridge 4a_{S}, 4b_{S} inserted in the compartment, by means of its pervious surfaces. In this way the cartridge 4a_{S}, 4b_{S} performs a chemical filtration of the circulating water.

In the light of the above the second compartment 40_{S} thus defines a chemical filtration stage of the filtration unit 1_{S}.

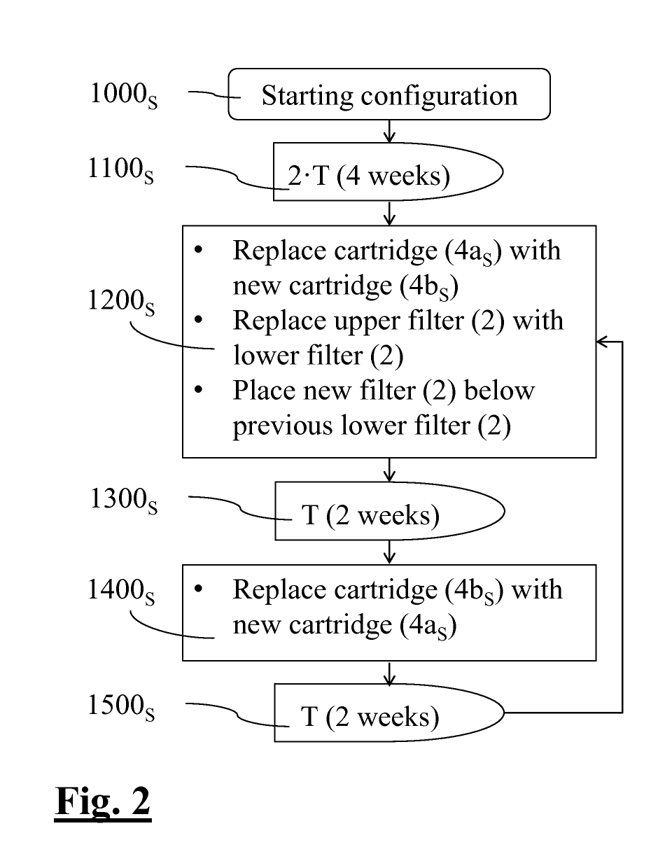

FIG. 2 presents a flowchart of a filtration method that uses the filtration unit 1_{S} described previously.

In a preliminary phase 1000_{S} a starting configuration of the filtration unit 1_{S} is established. In this starting configuration there are two mechanical filters 2_{S} located one on top of the other inside the first compartment 20_{S} and a cartridge containing activated carbon 4a_{S} inside the second compartment 40_{S}.

During a subsequent preliminary waiting period 1100_{S} the filtration unit 1_{S} is operational for a time period equal to the service period 2·T of the mechanical filters 2_{S}, i.e. for four weeks.

During operation the water, by means of the pump 5_{S}, is led along the filtration path 7_{S}; 20_{S}; 8_{S}; 40_{S} inside the filtration unit 1_{S}.

With the passage of time the mechanical filters 2_{S} will become progressively clogged up; contemporaneously, however, they become the seat of nitrifying bacterial flora that contribute to the biological filtration of the water.

In the meantime the activated carbon in the cartridge 4a_{S} proceeds with the removal of organic material to maintain high water quality in the aquarium 100_{S}. In the meantime, however, the phosphates and nitrates that have not been removed will accumulate in the water, so that after four weeks an environment has developed that stimulates algal proliferation; also the cartridge containing activated carbon 4a_{S} will increasingly become saturated and less efficacious.

In a subsequent first replacement step 1200_{S} the filters are replaced after four weeks have elapsed.

For the replacement the elements contained in a replacement kit 200_{S} are used.

The by now saturated cartridge containing activated carbon 4a_{S} is replaced by the cartridge containing material for the removal of nitrate and/or phosphate ions 4b_{S} of the replacement kit 200_{S}. The new cartridge will break down the nitrates/phosphates in the water, thus preventing the development of an environment that would be favorable to the formation of algae.

The topmost mechanical filter 2_{S}, most likely also clogged up, is removed. In its stead the mechanical filter 2_{S} previously located below is inserted. This filter is not yet clogged up, given that it was downstream from the first filter; in exchange nitrifying bacterial flora have developed on it, which are necessary for efficacious biological filtering. In the opened up lower position a new mechanical filter 2_{S} from the replacement kit 200_{S} is inserted.

Note that the replacement of the mechanical filters 2_{S} in the manner described above presents the advantage of having at all times a mechanical filter 2_{S} with nitrifying flora that perform the biological filtration. Thanks to this operation the filtration unit 1_{S} can contain one less separate biological filtration stage.

The new cartridge containing activated carbon 4a_{S}, present in the replacement kit 200_{S}, is not used at this moment but set aside for future use.

During a subsequent first waiting period 1300_{S} the filtration unit 1_{S} is operational for a time period equal to the service period T of the cartridges for chemical filtration 4a_{S}, 4b_{S}, i.e. for two weeks.

During this stage phosphates and nitrates are removed, preventing the formation of algae; in the meantime organic detritus accumulates that could lead in the subsequent period to a deterioration in water quality.

Efficacious biological filtration is performed by the bacterial flora present on the old mechanical filter 2_{S} placed in the top position; in the meantime new bacterial flora are formed on the new mechanical filter 2_{S} in the lower position.

In a subsequent second replacement step 1400_{S} only the chemical filter is replaced after two weeks have elapsed.

The now saturated cartridge containing material for the removal of nitrate and/or phosphate ions 4b_{S} is replaced by the cartridge containing activated carbon 4a_{S} previously set aside. The new cartridge will absorb the organic detritus, thereby preventing a deterioration in water quality.

During a subsequent second waiting period 1500_{S} the filtration unit 1_{S} is operational for a time period equal to the service period T of the cartridges for chemical filtration 4a_{S}, 4b_{S}, i.e. for two weeks.

During this stage the activated carbon contained in the cartridge 4a_{S} removes the organic pollution, while in the meantime phosphates and nitrates re-accumulate. The topmost mechanical filter 2_{S} begins to clog up; whereas on the lower mechanical filter nitrifying bacterial flora have established themselves.

At the end of this second waiting period 1500_{S}, the following steps are cyclically repeated: the first replacement step 1200_{S}; the first waiting phase 1300_{S}; the second replacement step 1400_{S}; and the second waiting phase 1500_{S}.

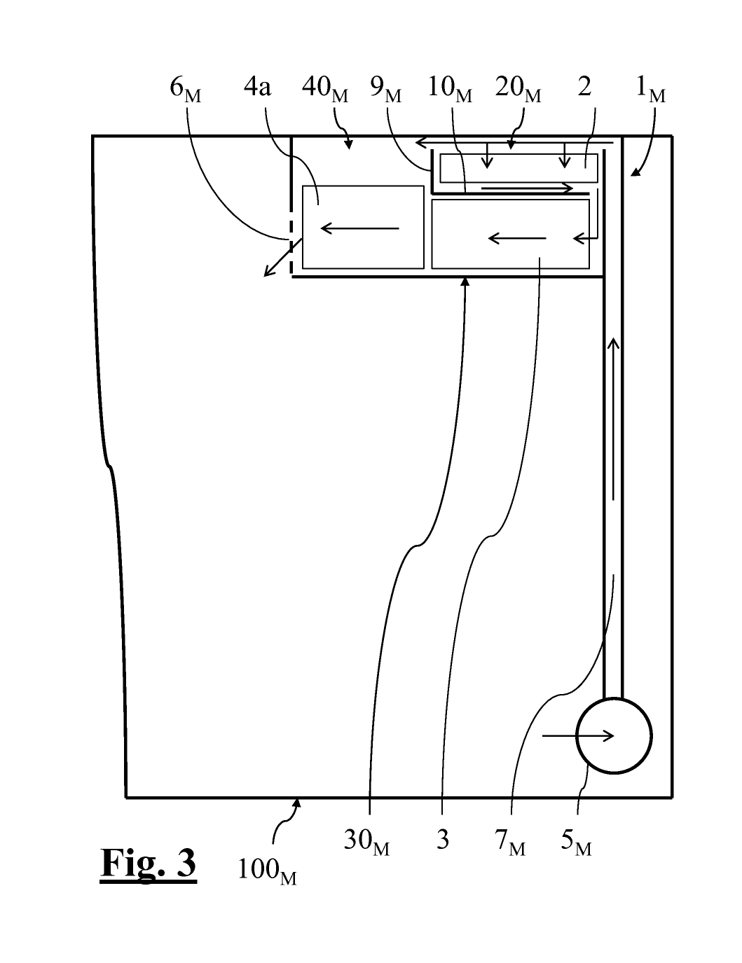

With reference to FIG. 3 the number 100_{M} identifies a medium-sized aquarium into which the filtration unit 1_{M} is integrated at the top. The filtration unit 1_{M} comprises a pump 5_{M} that draws in the water inside the aquarium 100_{M} to circulate it along a filtration path 7_{M}; 20_{M}; 30_{M}; 40_{M}.

The pump 5_{M}, located at the bottom of the aquarium 100_{M} and upstream of the filtration path 7_{M}; 20_{M}; 30_{M}; 40_{M}, leads the water through a delivery duct 7_{M}. The duct reaches an upper end of the filtration unit 1_{M}, at the point where it opens into a first compartment 20_{M}.

The first compartment 20_{M} is delimited by a vertical partition 9_{M} and a horizontal partition 10_{M}. The vertical partition 9_{M}, opposite the wall onto which the delivery duct 7_{M} opens, divides the first compartment 20_{M} from an adjacent third compartment 40_{M}. Through the vertical partition 9_{M} an upper overflow hole passes that allows the water to flow out of the first compartment 20_{M} in case of overfilling. The horizontal partition 10_{M} closes the first compartment 20_{M}, separating it from a second compartment 30_{M} below, in communication with the third compartment 40_{M}. The horizontal partition is traversed by an outflow hole located near the wall onto which the delivery duct 7_{M} opens.

The first compartment 20_{M} is designed to house a mechanical filter 2, of the type contained in the second replacement kit 200 previously described. The mechanical filter 2 covers the horizontal partition 10_{M}, so that the water coming from the delivery duct 7_{M} passes through it by gravitational effect, to reach the outflow hole made in that partition. The mechanical filter 2 captures the particulate matter suspended in the water passing through it, thus performing the mechanical filtration.

In the light of the above the first compartment 20_{M} thus defines a mechanical filtration stage of the filtration unit 1_{M}.

The second compartment 30_{M} is designed to house a cartridge for biological filtration 3. This cartridge 3 consists of an external container, through which opportunely the water to be filtered can pass, containing elements that promote the formation of nitrifying bacterial flora on their surfaces. These elements are preferably in the form of porous ceramic cylinders. To allow the passage of the water that is to be filtered, at least the lateral surfaces of the biological filtration cartridge are pervious.

Note that the biological filtration cartridge 3 is preferably inserted in an extractable manner inside the filtration unit 1_{M}. To allow the cartridge to be extracted the horizontal partition 10_{M} can be removed, or can even be formed by an upper non-pervious surface of the biological filtration cartridge 3.

The water that enters the second compartment 30_{M} through the outflow hole of the horizontal partition 10_{M} passes through the entire biological filtration cartridge 3 before reaching the adjacent third compartment 40_{M}. In this way the cartridge 3 filters the water biologically, breaking down toxic nitrogenous compounds into nitrates.

In the light of the above the second compartment 30_{M} thus defines a biological filtration stage of the filtration unit 1_{M}.

The third compartment 40_{M} is designed to house a cartridge containing activated carbon 4a, or alternately a cartridge containing material for the removal of nitrate and/or phosphate ions 4b. Both cartridges are contained in the first replacement kit described previously. The water coming from the second compartment 30_{M} passes through the third compartment 40_{M} before being returned to the aquarium 100_{M} through an opposite exit opening 6_{M}. The water that passes through the third compartment 40_{M} therefore transits through the interior of the cartridge 4a, 4b inserted in the compartment, by means of its pervious surfaces. In this way the cartridge 4a, 4b performs a chemical filtration of the circulating water.

In the light of the above the third compartment 40_{M} thus defines a chemical filtration stage of the filtration unit 1_{M}.

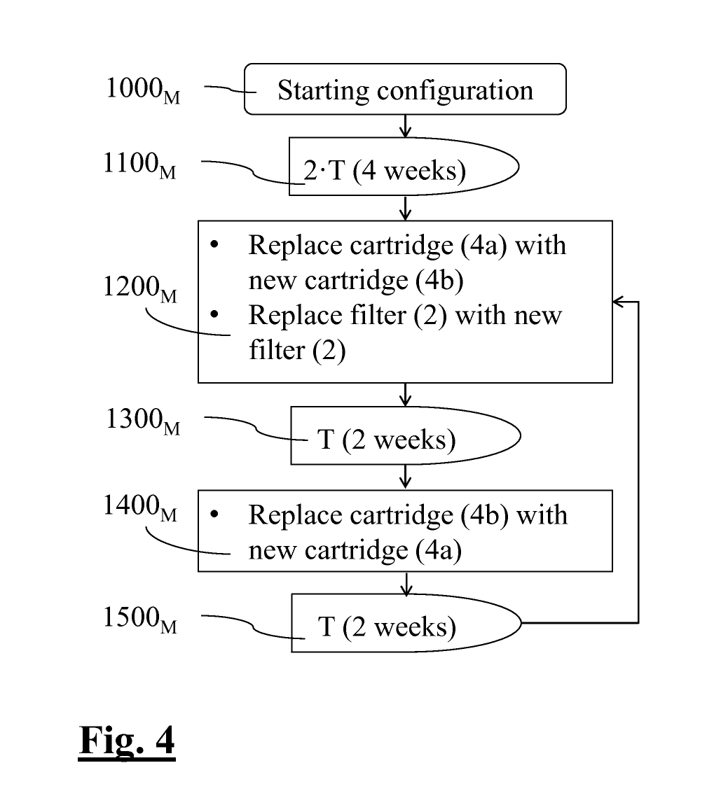

FIG. 4 presents a flowchart of a filtration method that uses the filtration unit 1_{M} described previously.

In a preliminary phase 1000_{M} a starting configuration of the filtration unit 1_{M} is established. In this starting configuration there is a mechanical filter 2 located inside the first compartment 20_{M}, a cartridge for biological filtration 3 inside the second compartment 30_{M}, and a cartridge containing activated carbon 4a inside the third compartment 40_{M}.

During a subsequent preliminary waiting period 1100_{M} the filtration unit 1_{M} is operational for a time period equal to the service period 2·T of the mechanical filters 2, i.e. for four weeks.

During operation the water, by means of the pump 5_{M}, is led along the filtration path 7_{M}; 20_{M}; 30_{M}; 40_{M} inside the filtration unit 1_{M}.

With the passage of time the activated carbon of the cartridge 4a will remove organic pollution, keeping the water of the aquarium 100_{M} clean. In the meantime, however, the phosphates and nitrates that have not been removed will accumulate in the water, so that after four weeks an environment has developed that stimulates algal proliferation; also the cartridge containing activated carbon 4a will increasingly become saturated and less efficacious.

The material contained by the biological filtration cartridge 3 in the meantime has become the seat of nitrifying flora that effectively eliminate the toxic nitrogenous compounds in the water.

In a subsequent first replacement step 1200_{M} the filters are replaced after four weeks have elapsed.

For the replacement the elements contained in a replacement kit 200 are used.

The by now saturated cartridge containing activated carbon 4a is replaced by the cartridge containing material for the removal of nitrate and/or phosphate ions 4b_{S} of the replacement kit 200. The new cartridge will break down the nitrates/phosphates in the water, thus preventing the development of an environment that would be favorable to the formation of algae.

The mechanical filter 2, most likely clogged up, is replaced by the new mechanical filter from the replacement kit 200.

The new cartridge containing activated carbon 4a of the replacement kit 200 is not used at this moment but set aside for future use.

During a subsequent first waiting period 1300_{M} the filtration unit 1_{M} is operational for a time period equal to the service period T of the cartridges for chemical filtration 4a, 4b, i.e. for two weeks.

During this stage phosphates and nitrates are removed, preventing the formation of algae; in the meantime organic detritus accumulates that could lead in the subsequent period to a deterioration in water quality.

In a subsequent second replacement step 1400_{M} only the chemical filter is replaced after two weeks have elapsed.

The by now saturated cartridge containing material for the removal of nitrate and/or phosphate ions 4b is replaced by the cartridge containing activated carbon previously set aside. The new cartridge will absorb the organic detritus, thereby preventing deterioration in water quality.

During a subsequent second waiting period 1500_{M} the filtration unit 1_{M} is operational for a time period equal to the service period T of the cartridges for chemical filtration 4a, 4b, i.e. for two weeks.

During this stage the activated carbon contained in the cartridge 4a removes the organic pollution, while in the meantime phosphates and nitrates re-accumulate.

At the end of this second waiting period 1500_{M}, the following steps are cyclically repeated: the first replacement step 1200_{M}; the first waiting phase 1300_{M}; the second replacement step 1400_{M}; and the second waiting phase 1500_{M}.

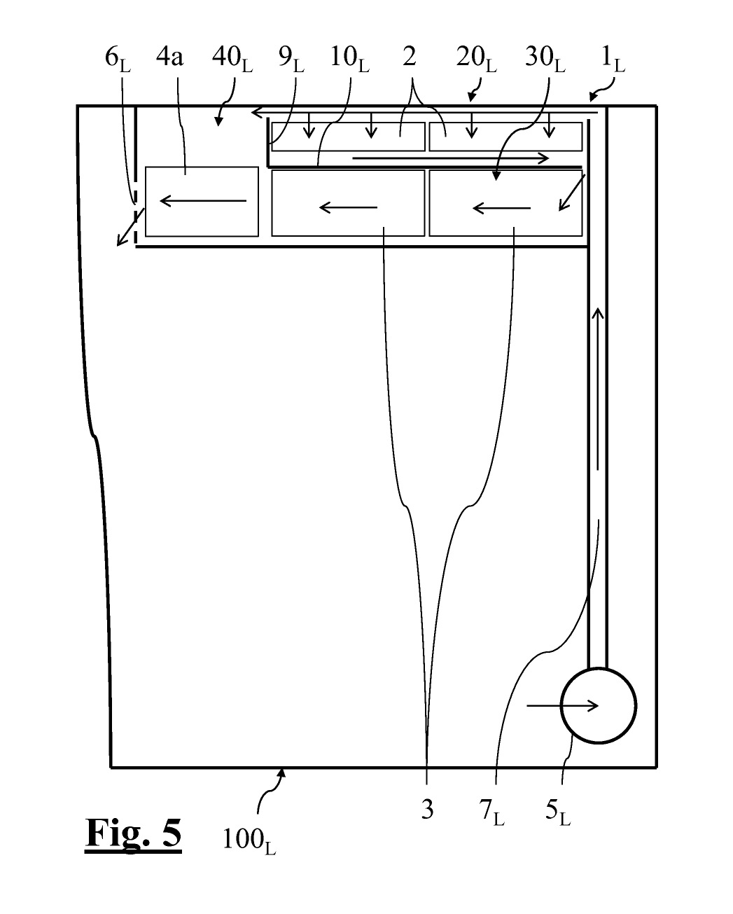

With reference to FIG. 5 the number 100_{L} identifies a large-sized aquarium into which the filtration unit 1_{L} is integrated at the top. The filtration unit 1_{L} is structurally identical to the previously described unit for medium-sized aquaria 1_{M}, with the exception of different dimensions of the compartments to allow a greater number of filtration elements to be introduced.

In particular the filtration unit 1_{L} comprises a pump 5_{L} with delivery duct 7_{L}; a first 20_{L}, second 30_{L} and third 40_{L} compartment, divided from each other by a vertical partition 9_{L} and a horizontal partition 10_{L}; and an open exit grid 6_{L}, whose configurations are all analogous to the corresponding elements described with reference to the filtration unit 1_{M} for medium-sized aquaria.

The only substantial difference is the horizontal dimension of the first 20_{L} and the second 30_{L} compartments, which are respectively designed to house two mechanical filters 2 and two biological filtration cartridges 3.

The biological filtration cartridges 3 are located in series along the filtered water's direction of circulation; in other words a first cartridge abuts against the wall contiguous to the delivery duct 7_{L}, whereas the second cartridge is located in proximity to the third compartment 40_{L}. In this way the water coming from the first compartment 20_{L} passes through both biological filtration cartridges 3 before arriving at the third compartment 40_{L}.

The mechanical filters 2 are substantially placed over the two biological filtration cartridges 3. In this way the water coming from the delivery duct 7_{L} can reach the bottom of the first compartment 20_{L} passing through either of the two mechanical filters 2. For the present purposes the mechanical filter 2 closest to the outlet of the delivery duct 7_{L} will be called the upstream filter, while the filter 2 nearer the vertical partition 9_{L} will be called the downstream filter.

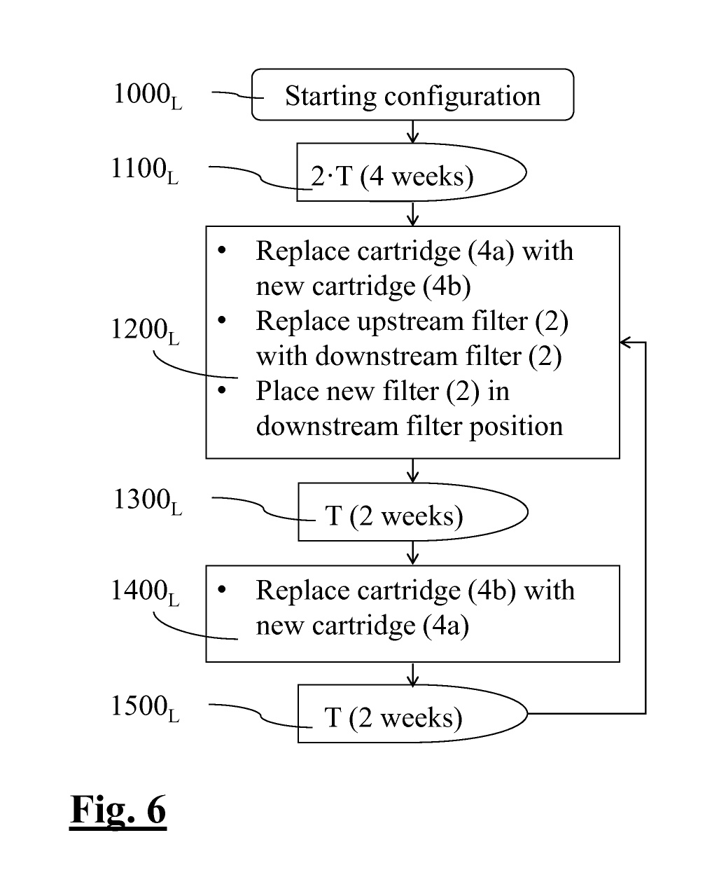

FIG. 6 presents a flowchart of a filtration method that uses the filtration unit 1_{L} described previously.

The method described in detail below, is substantially analogous to the one described previously in relation to the filtration unit 1_{M}; all previous considerations presented with reference to the operation of the filters as a result also apply to the present method.

In a preliminary phase 1000_{L} a starting configuration of the filtration unit 1_{L} is established. In this starting configuration there are two mechanical filters 2 juxtaposed inside the first compartment 20_{L}, two cartridges for biological filtration 3 inside the second compartment 30_{L} and a cartridge containing activated carbon 4a inside the second compartment 40_{L}.

During a subsequent preliminary waiting period 1100_{L} the filtration unit 1_{L} is operational for a time period equal to the service period 2·T of the mechanical filters 2, i.e. for four weeks.

In a subsequent first replacement step 1200_{L} the filters are replaced after four weeks have elapsed.

For the replacement the elements contained in a replacement kit 200 are used.

The cartridge containing activated carbon 4a is replaced by the cartridge containing material for the removal of nitrate and/or phosphate ions 4b of the replacement kit 200.

The upstream mechanical filter 2, the one nearest the outlet of the delivery duct 7_{L} and containing the greatest quantity of detritus, is removed. In its place the mechanical filter 2 previously located downstream is inserted. This filter is most likely less clogged; also nitrifying bacterial flora have developed on it, useful for the removal of toxic nitrogenous compounds. In the opened up downstream position a new mechanical filter 2 from the replacement kit 200 is inserted.

The new cartridge containing activated carbon 4a, present in the replacement kit 200, is not used at this moment but set aside for future use.

During a subsequent first waiting period 1300_{L} the filtration unit 1_{L} is operational for a time period equal to the service period T of the cartridges for chemical filtration 4a, 4b, i.e. for two weeks.

In a subsequent second replacement step 1400_{L} the cartridge containing material for the removal of nitrate and/or phosphate ions 4b is replaced by the cartridge containing activated carbon 4a previously set aside.

During a subsequent second waiting period 1500_{L} the filtration unit 1_{L} is operational for a time period equal to the service period T of the cartridges for chemical filtration 4a, 4b, i.e. for two weeks.

At the end of this second waiting period 1500_{L}, the following steps are cyclically repeated: the first replacement step 1200_{L}; the first waiting phase 1300_{L}; the second replacement step 1400_{L}; and the second waiting phase 1500_{L}.

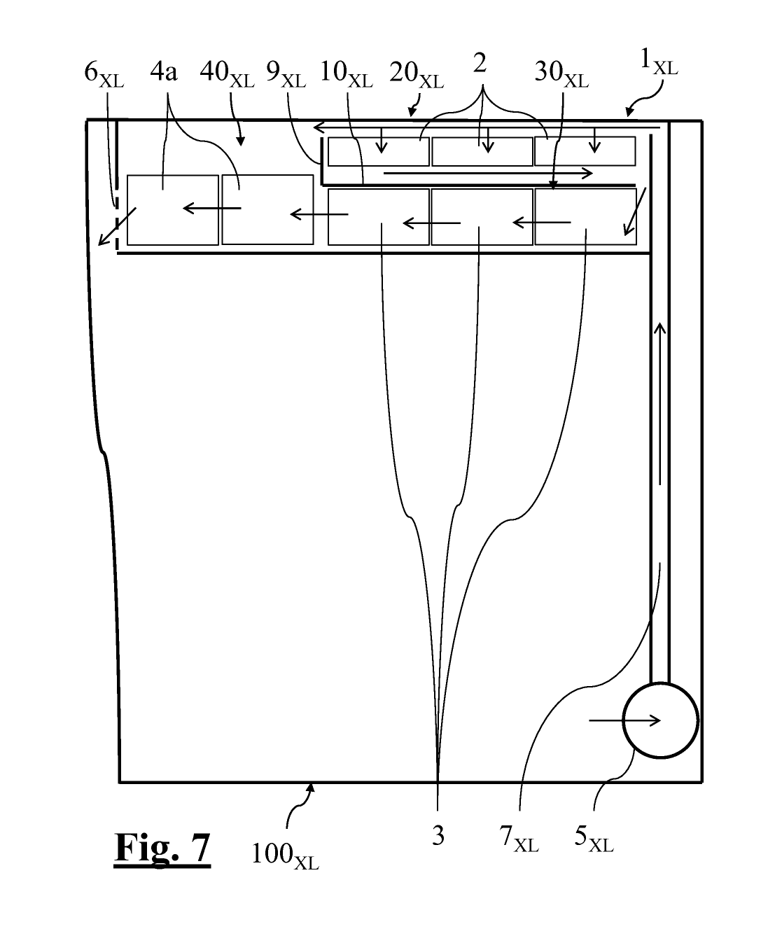

With reference to FIG. 7 the number 100X_{L} identifies a very large-sized aquarium into which the filtration unit 1_{XL} is integrated at the top. The filtration unit 1_{XL} is structurally identical to the previously described unit for medium-sized aquaria 1_{M}, with the exception of different dimensions of the compartments to allow a greater number of filtration elements to be introduced.

In particular the filtration unit 1_{XL} comprises a pump 5_{XL} with delivery duct 7_{XL}; a first 20_{XL}, second 30_{XL} and third 40_{XL} compartment, divided from each other by a vertical partition 9_{XL} and a horizontal partition 10_{XL}; and an open exit grid 6_{XL}, whose configurations are all analogous to the corresponding elements described with reference to the filtration unit 1_{M} for medium-sized aquaria.

The only substantial difference is the horizontal dimension of the first 20_{XL}, second 30_{XL} and third 40_{XL} compartments, which are respectively designed to house three mechanical filters 2, three biological filtration cartridges 3 and two chemical filtration cartridges 4a or 4b.

The biological filtration cartridges 3 are located in series along the filtered water's direction of circulation; in other words a first cartridge abuts against the wall contiguous to the delivery duct 7_{XL}, whereas the third and last cartridge is located in proximity to the third compartment 40_{XL}. In this way the water coming from the first compartment 20_{XL} passes through the series of three biological filtration cartridges 3 before arriving at the third compartment 40_{XL}.

The mechanical filters 2 are substantially placed above the three biological filtration cartridges 3. In this way the water coming from the delivery duct 7_{XL} can reach the bottom of the first compartment 20_{XL} passing through any of the three mechanical filters 2. For the present purposes the mechanical filter 2 closest to the outlet of the delivery duct 7_{XL}, will be called the upstream filter, while the filter 2 nearer the vertical partition 9_{XL} will be called the downstream filter.

The two cartridges containing activated carbon 4a, or alternately containing material for the removal of nitrate and/or phosphate ions 4b, are located in series along the filtered water's direction of circulation; in other words the first cartridge is located in proximity to the second compartment 30_{XL} whereas the second cartridge rests on the open exit grid 6_{XL}. In this way the water coming from the first compartment 20_{XL} or the second compartment 30_{XL}, passes through both cartridges before reentering the aquarium 100_{XL}.

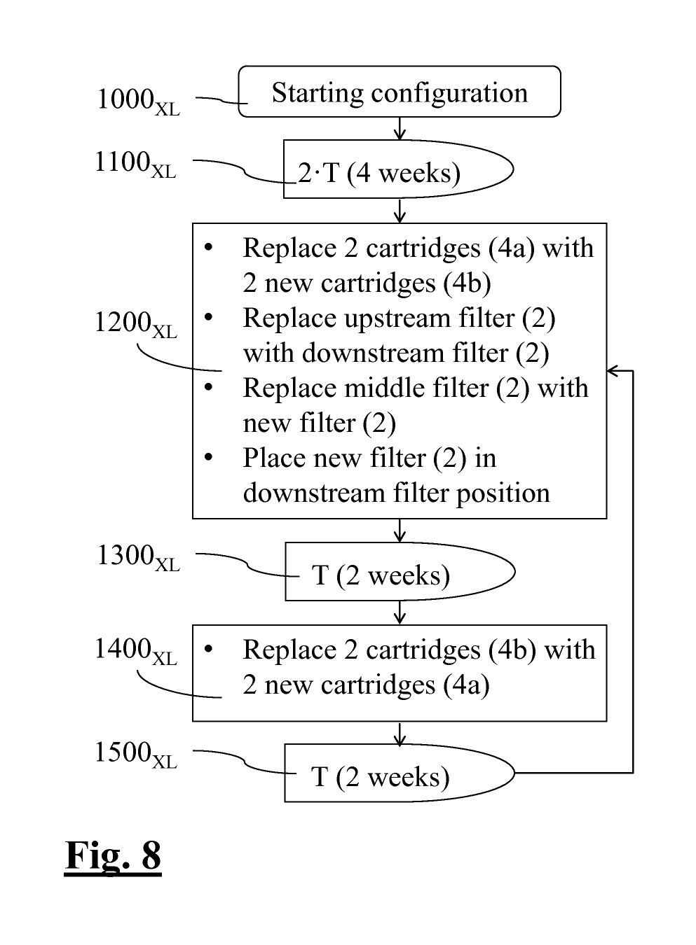

FIG. 8 presents a flowchart of a filtration method that uses the filtration unit 1_{XL} described previously.

The method described in detail below, is substantially analogous to the one described previously in relation to the filtration unit 1_{M}; all previous considerations presented with reference to the operation of the filters as a result also apply to the present method.

In a preliminary phase 1000_{XL} a starting configuration of the filtration unit 1_{XL} is established. In this starting configuration there are three mechanical filters 2 juxtaposed inside the first compartment 20_{XL}, three cartridges for biological filtration 3 inside the second compartment 30_{XL} and two cartridges containing activated carbon 4a inside the third compartment 40_{XL}.

During a subsequent preliminary waiting period 1100_{XL} the filtration unit 1_{XL} is operational for a time period equal to the service period 2·T of the mechanical filters 2, i.e. for four weeks.

In a subsequent first replacement step 1200_{XL} the filters are replaced after four weeks have elapsed.

For the replacement the elements contained in two replacement kits 200 are used.

Both cartridges containing activated carbon 4a are replaced by two cartridges containing material for the removal of nitrate and/or phosphate ions 4b of the two replacement kits 200.

The upstream mechanical filter 2 and the middle filter, being the ones nearest the outlet of the delivery duct 7_{XL} and containing the greatest quantity of detritus, are removed. In the upstream position the mechanical filter 2 previously located downstream is inserted. This filter is most likely less clogged; also nitrifying bacterial flora have developed on it, useful for the removal of toxic nitrogenous compounds. In the opened up downstream position and the middle position two new mechanical filters 2 from the two replacement kits 200 are inserted.

The new cartridges containing activated carbon 4a, present in the two replacement kits 200, are not used at this moment but set aside for future use.

During a subsequent first waiting period 1300_{XL} the filtration unit 1_{XL} is operational for a time period equal to the service period T of the cartridges for chemical filtration 4a, 4b, i.e. for two weeks.

In a subsequent second replacement step 1400_{XL} the two cartridges containing material for the removal of nitrate and/or phosphate ions 4b are replaced by the two cartridges containing activated carbon 4a previously set aside.

During a subsequent second waiting period 1500_{XL} the filtration unit is operational for a time period equal to the service period T of the cartridges for chemical filtration 4a, 4b, i.e. for two weeks.

At the end of this second waiting period 1500_{XL}, the following steps are cyclically repeated: the first replacement step 1200_{XL}; the first waiting phase 1300_{XL}; the second replacement step 1400_{XL}; and the second waiting phase 1500_{XL}.

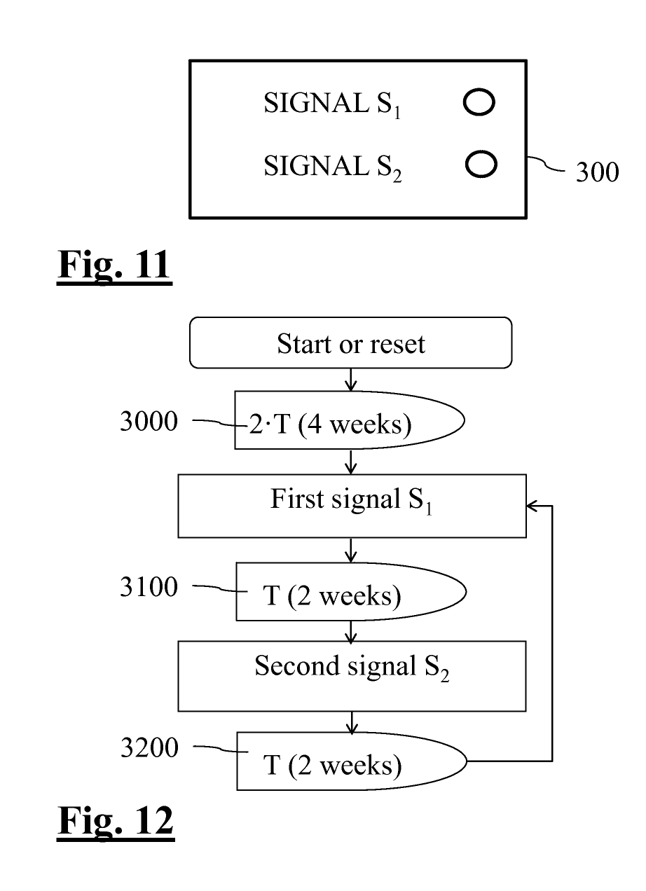

The filtration methods described above can advantageously make use of an electronic signalization device 300, possibly integrated into the filtration unit 1_{S,M,X,XL}, illustrated in FIG. 11.

According to an operation illustrated in FIG. 12 a first timer 3000 is started when the signalization device 300 is turned on or reset. After four weeks the timer determines the emission of a first signal S₁ corresponding to the first replacement phase 1200_{S,M,X,XL} of the methods previously discussed. Upon completion of this replacement a second timer 3100 is triggered that after two weeks determines the emission of a second signal S₂ corresponding to the second replacement phase 1400_{S,M,X,XL}. Then a third timer 3200 is started that determines the emission of a new first signal S₁ and so on until the device is reset.

The signals S₁ and S₂ can be optical, acoustic, electric, or other. The signalization device 300 can be connected to a control unit of the filtration unit 1_{S,M,X,XL}, or possibly integrated inside it. The communication between the control unit and the signalization device 300 can for instance automatically start the timers of the signalization device 300 each time the filtration unit 1_{S,M,X,XL} is turned on again after maintenance.

Obviously a person skilled in the art can apply numerous modifications and variations to the methods and devices described above to meet with specific and contingent needs; these would nevertheless all fall within the scope of protection of the invention as described in the following claims.

1. A method for filtering water in an aquarium by means of a filtration unit, said method comprising:
leading water circulation along a filtration path that comprises at least a chemical filtration stage, said chemical filtration stage comprising at least a cartridge containing activated carbon or a cartridge containing material for the removal of nitrate and/or phosphate ions;
cyclically replacing said cartridge, over time alternating cartridges with activated carbon and cartridges with material for the removal of nitrate and/or phosphate ions.

2. The method according to claim 1, wherein the step of replacing the cartridge is performed after a service period for said cartridge has elapsed.

3. The method according to claim 2, wherein said service period is predetermined and constant for both the cartridges containing activated carbon and the cartridges containing material for the removal of nitrate and/or phosphate ions.

4. The method according to claim 3, wherein said service period is between ten and twenty days.

5. The method according to claim 4, wherein said service period is two weeks.

6. The method according to claim 1, wherein said filtration path furthermore comprises at least one mechanical filtration stage, said mechanical filtration stage comprising at least a mechanical filter; said method furthermore comprising a replacement step for said mechanical filter concomitant with one of the cartridge replacements of the chemical filtration stage.

7. The method according to claim 6, wherein the replacement step of the cartridge of the chemical filtration stage is executed after a predetermined and constant service period for both the cartridges containing activated carbon and the cartridges containing material for the removal of nitrate and/or phosphate ions has elapsed; and wherein the replacement step of the mechanical filter is executed after a service period has elapsed that is twice as long as the service period of said cartridges.

8. The method according to claim 1, wherein said filtration path furthermore comprises at least a mechanical filtration stage, said mechanical filtration stage comprising at least two mechanical filters; said method furthermore comprising the following cyclically repeating steps:
replacing a number of mechanical filters less than the total number of mechanical filters in the mechanical filtration stage;
replacing, in a subsequent moment, a number of mechanical filters less than the total number of mechanical filters in the mechanical filtration stage, said number of filters at least containing the mechanical filters that have not been replaced in the previous step.

9. The method according to claim 8, wherein in said steps of replacing a number of mechanical filters, the filters that are replaced are those located more upstream in the filtration path, while the mechanical filters that are not replaced are moved into the positions vacated by the replaced filters.

10. The method according to claim 9, wherein the mechanical filtration stage comprises two mechanical filters in series, through which the water to be filtered passes in succession, and wherein in the replacement steps of a number of mechanical filters, the downstream mechanical filter replaces the upstream mechanical filter and a new mechanical filter replaces the downstream mechanical filter.

11. The method according to claim 9, wherein the mechanical filtration stage comprises two mechanical filters in parallel, through which the water to be filtered passes in succession, located in an upstream position nearer to a water intake in the mechanical filtration stage and in a downstream position farther from said water intake, and wherein in said replacement stage of a number of mechanical filters, the mechanical filter previously located in the downstream position is moved to the upstream position and a new mechanical filter is placed in the downstream position.

12. The method according to claim 9, wherein the mechanical filtration stage comprises three mechanical filters in parallel, through which the water to be filtered passes in succession, located in an upstream position nearer a water intake in the mechanical filtration stage, in a downstream position farther from said water intake and in an intermediate position comprised between said upstream and downstream positions, and wherein in said replacement steps of a number of mechanical filters, the mechanical filter previously located in the downstream position is moved to the upstream position and two new mechanical filter are placed in the downstream and intermediate positions.

13. A filtration unit for aquarium comprising a filtration path and means to lead the circulation of the aquarium water along said path, said filtration path at least comprising a chemical filtration stage designed to contain alternately and in a replaceable manner a cartridge containing activated carbon or a cartridge containing material for the removal of nitrate and/or phosphate ions.

14. The filtration unit according to claim 13, wherein the filtration path further comprises a mechanical filtration stage designed to contain a plurality of mechanical filters, said mechanical filters being interchangeable and singly replaceable.

15. The filtration unit according to claim 13, further comprising a signalization device designed to emit at least a warning signal for the replacement of the cartridge containing activated carbon by a cartridge containing material for the removal of nitrate and/or phosphate ions or vice versa.

16. A replacement kit for filtration units for aquaria comprising a cartridge containing activated carbon and a cartridge containing material for the removal of nitrate and/or phosphate ions, said cartridges being replaceable one with the other inside the filtration unit for aquaria.

17. The replacement kit according to claim 16, further comprising a mechanical filter.
